(19) United States
(12) Patent Application Publication
(10) Pub. No.: US 2012/0027428 A1
(43) Pub. Date: Feb. 2, 2012

(54) SHEET FINISHER, IMAGE FORMING APPARATUS AND SHEET FINISHING METHOD

(75) Inventor: Yasunobu TERAO, Shizuoka-Ken (JP)

(73) Assignees: Toshiba Tec Kabushiki Kaisha, Tokyo (JP); Kabushiki Kaisha Toshiba, Tokyo (JP)

(21) Appl. No.: 13/192,337

(22) Filed: Jul. 27, 2011

Related U.S. Application Data
(60) Provisional application No. 61/368,591, filed on Jul. 28, 2010.

(51) Int. Cl. G03G 15/00; B31F 1/10

(52) U.S. Cl. 399/21; 493/442

(57) ABSTRACT

There is provided a sheet finisher including a fold roller which folds the center of a sheet bundle and forms a fold line in the sheet bundle; a roller unit which is provided with an upper roller and a lower roller and which moves the upper roller and the lower roller along a fold line direction, while nipping and pressing the fold line by the upper roller and the lower roller to reinforce the fold line; and a jam release handle which separates the upper roller and the lower roller in a thickness direction of the sheet bundle and weakens or removes pressure between the upper roller and the lower roller when the upper roller and the lower roller stops in a state of pressing the fold line.

### CROSS-REFERENCE TO RELATED APPLICATIONS

This application is based upon and claims the benefit of priority from: U.S. provisional application 61/368,591 filed on Jul. 28, 2010, the entire contents of which are incorporated herein by reference.

### FIELD

The invention relates to a sheet finisher, an image forming apparatus, and a sheet finishing method.

### BACKGROUND

Conventionally, a sheet finisher is known which is disposed on the downstream side of an image forming apparatus such as a copier, a printer, or a multi-functional peripheral (MFP) device and which performs finishing such as hole punching or binding with regard to a sheet which has been printed on.

Recently, the functions of the sheet finisher have become varied and a sheet finisher has been proposed which has a saddle-stitching function with which a sheet is folded in the center portion of the sheet after the center portion has been stapled, in addition to the functions of hole opening or binding.

In the sheet finisher which has the saddle-stitching function, it is possible to form a booklet (manufacture a book) from a plurality of printed sheets.

In the saddle-stitching process in the past, after binding by stapling or the like in the center portion of the sheet, a fold line is formed in a binding portion by a pair of rollers called fold rollers. A fold line is formed in a sheet bundle by a member with a plate shape which is called a fold blade being brought into contact with the binding portion of the sheet bundle and pressed into a nip portion of the pair of fold rollers.

However, since there is only a short time for pressing the fold portion of the sheet bundle using the nip portion of the fold rollers and the entire fold portion is simultaneously pressed by the fold rollers, pressure is dispersed on the entire fold. As a result, sufficient pressure is not necessarily applied to the fold line. In particular, the fold line is often incomplete when the number of sheets is large or when a thick sheet is included in the sheet bundle.

In order to solve the problem, a fold reinforcing device is known which reinforces the fold line by nipping the fold line pushed out from the fold rollers in a nip portion of a pair of fold reinforcing rollers and moving the pair of reinforcing rollers along the folding line while pressing the fold line.

When there is a paper jam during movement of the reinforcing rollers due to any cause, the reinforcing rollers stop in a state where pressure is applied to the fold line. The sheet bundle which has caused the paper jam stays in a position which is not normally visually identifiable from the outside. In addition, since a high pressure by the reinforcing rollers is applied to the sheet bundle, it is not easy to remove the jammed sheet bundle.

Thus, a sheet finisher, an image forming apparatus, and a sheet finishing method are desired which make it possible to easily remove the sheet bundle from inside the sheet finisher even when such paper jam occurs.

### DESCRIPTION OF THE DRAWINGS

FIG. 1 is a perspective diagram illustrating an example of an outer appearance of an image forming apparatus according to an embodiment of the invention.

FIG. 2 is a cross-sectional diagram illustrating a configuration example of an image forming apparatus according to an embodiment of the invention.

FIG. 3 is a cross-sectional diagram illustrating a configuration example of a saddle stitching unit.

FIG. 4 is a perspective diagram illustrating an outer appearance of an entire configuration of a fold reinforcing unit.

FIGS. 5A and 5B are schematic cross-sectional diagrams mainly describing a configuration of a support unit.

FIG. 6 is a perspective diagram illustrating an outer appearance of a configuration example of a roller unit.

FIG. 7 is a diagram of the fold reinforcing unit viewed from where a sheet bundle has been sent.

FIG. 8 is a first diagram describing up-and-down driving mechanism of an upper roller.

FIG. 9 is a second diagram describing the up-and-down driving mechanism of the upper roller.

FIG. 10 is a first diagram describing a first jam release mechanism.

FIGS. 11A and 11B are second diagrams describing the first jam release mechanism.

FIGS. 12A and 12B are third diagrams describing the first jam release mechanism.

FIGS. 13A and 13B are first diagrams describing a second jam release mechanism.

FIG. 14 is a second diagram describing the second jam release mechanism.

FIGS. 15A and 15B are third diagrams describing the second jam release mechanism.

### DETAILED DESCRIPTION

An embodiment of a sheet finisher, an image forming apparatus, and a sheet finishing method will be described with reference to the attached diagrams.

The sheet finisher according to the embodiment is provided with a fold roller which folds the center of a sheet bundle and forms a fold line in the sheet bundle; a roller unit which is provided with an upper roller and a lower roller and which moves the upper roller and the lower roller along a fold line direction, while nipping and pressing the fold line by the upper roller and the lower roller to reinforce the fold line; and a jam release handle which separates the upper roller and the lower roller in a thickness direction of the sheet bundle and weakens or removes pressure between the upper roller and the lower roller when the upper roller and the lower roller stops in a state of pressing the fold line.

### (1) Configuration

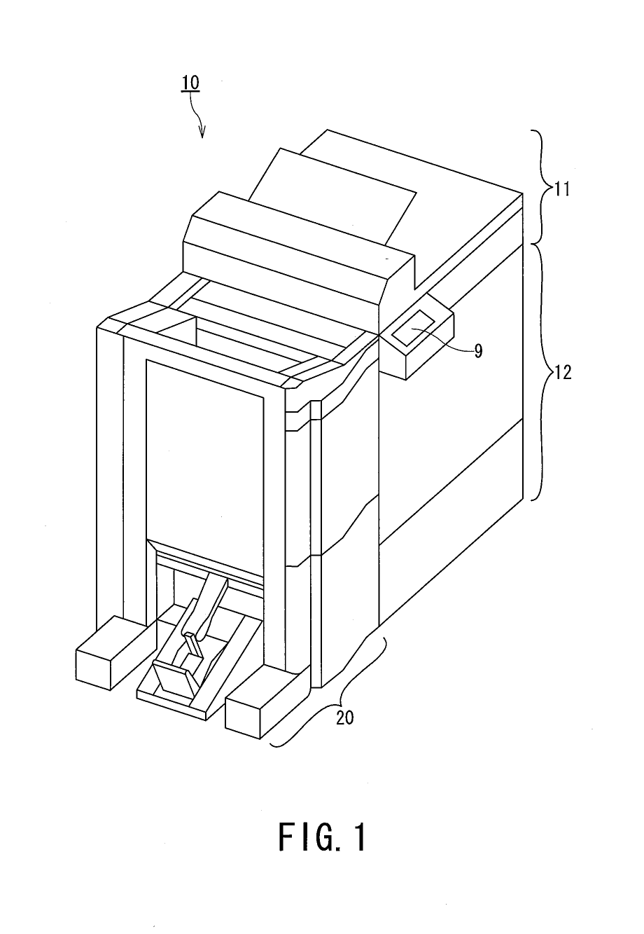

FIG. 1 is a perspective diagram illustrating an outer appearance of a basic configuration of an image forming apparatus 10 according to an embodiment. The image forming apparatus 10 is configured by being provided with a read-out unit 11 which reads out an original document, an image forming unit 12 which prints out image data of the read-out original document onto a sheet using an electrophotographic method, a sheet finisher 20 which performs finishing such as sorting, hole opening, folding, and saddle stitching in regard to a sheet which has been printed. In addition, the image forming unit 12 is provided with an operation unit 9 for a user to perform various operations.

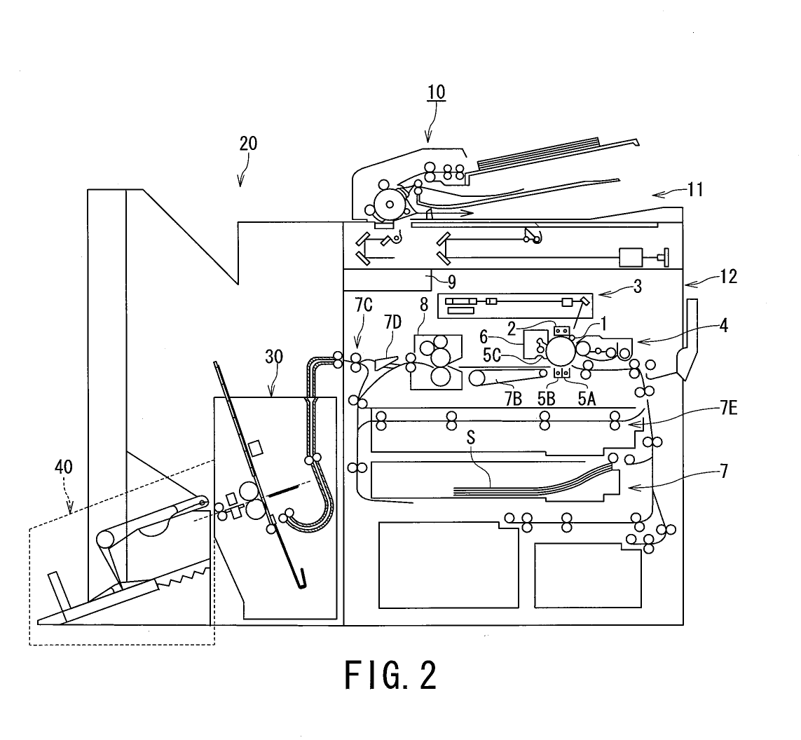

FIG. 2 is a cross-sectional diagram illustrating a detailed configuration example of the image forming apparatus 10.

The image forming unit 12 of the image forming apparatus 10 has a photoconductor drum 1 in the vicinity of a center portion, and a charging unit 2, an exposure unit 3, a development unit 4, a transfer unit 5A, a charge removing unit 5B, a separating claw 5C, and a cleaning unit 6 are each provided in the vicinity of the photoconductor drum 1. In addition, a transfer unit 8 is provided on the downstream side of the charge removing unit 5B. Image forming is performed as in the sequence outlined next using each of these units.

First, uniform charging is performed on the surface of the photoconductor drum 1 using the charging unit 2. On the other hand, the original document which is readout at the read-out unit 11 is converted to image data and the image data is input into the exposure unit 3. In the exposure unit 3, a laser beam is radiated onto the photoconductor drum 1 according to the level of the image data and an electrostatic latent image is formed on the photoconductor drum 1. The electrostatic latent image is developed using toner supplied from the development unit 4 and a toner image is formed on the photoconductor drum 1.

On the other hand, a sheet accommodated in a sheet accommodation unit 7 is transported to a transfer position (gap between the photoconductor drum 1 and the transfer unit 5A) by several transport rollers. At the transfer position, the toner image is transferred from the photoconductor drum 1 to the sheet by the transfer unit 5A. The electric charge on the surface is erased by the charge removing unit 5B, and the sheet on which the toner image has been transferred is separated from the photoconductor drum 1 by the separating claw 5C. After that, the sheet is transported by an intermediate transport unit 7B and is heated and pressed by a fixing unit 8, so that the toner image is fixed to the sheet. The sheet which has been subjected to the fixing is discharged from a discharge unit 7C and is outputted to the sheet finisher 20.

Developing agent which remains on the surface of the photoconductor drum 1 is removed by the cleaning unit 6 at the downstream side of the separating claw 5C, and preparation is performed for next image formation.

Here, when double-sided printing is performed, the sheet which has had the toner image fixed to its surface is branched off from the normal discharge path by a transport path switching plate 7D, is switched back at a reverse transport unit 7E, and is turned inside-out. Printing in the same manner as the single sided printing is performed on the back surface of the reversed sheet, and the sheet is output from the discharge unit 7C to the sheet finisher 20.

The sheet finisher 20 has a saddle stitching unit 30 and a sheet bundle placement unit 40 in addition to a sorter unit (not shown) which performs sorting of the sheets.

The saddle stitching unit 30 performs a process (binding) in which a center portion of a plurality of sheets which has been printed upon and discharged from the image forming unit 12 is bound with staples, and then, folding is performed to form a booklet.

The booklet which is subject to binding by the saddle stitching unit 30 is output to the sheet bundle placement unit 40, and the made booklet is finally arranged.

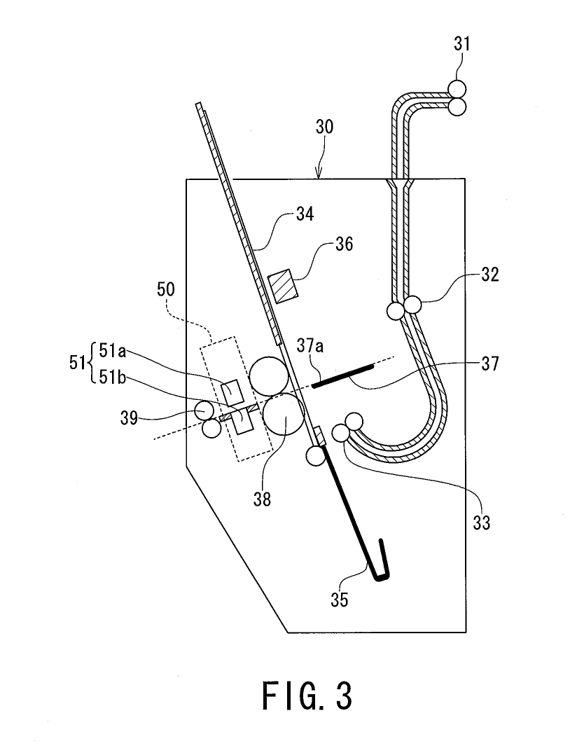

FIG. 3 is a cross-sectional diagram illustrating a detailed configuration example of the saddle stitching unit 30.

In the saddle stitching unit 30, the sheet discharged from the discharge unit 7C of the image forming unit 12 is received by a pair of input rollers 31 and is delivered to a pair of intermediate rollers 32. The pair of intermediate rollers 32 further delivers the sheet to a pair of output rollers 33. The pair of output rollers 33 sends the sheet to a standing tray 34 with an inclined placement surface. The leading edge of the sheet is directed to the upper portion of the inclination of the standing tray 34.

A stacker 35 waits below the standing tray 34, and receives the lower edge of the sheet which has been switched back and has fallen from the upper part of the inclination of the standing tray 34.

A stapler 36 is provided at substantially the middle of the standing tray 34. When binding (stapling) is performed on the sheet bundle, the position of the stacker 35 is adjusted so that the position of the sheet bundle which is to be stapled (the center of the sheet bundle in the up-and-down direction) faces the stapler 36.

When the sheet bundle is bound by the stapler 34, next, the stacker 35 is lowered until the position of the sheet bundle, where a fold line is to be formed (the center of the sheet bundle in the up-and-down direction and the position where the staples have been inserted), is in front of a fold blade 37.

When the position where the fold line is to be formed is in front of the fold blade 37, a leading edge 37a of the fold blade 37 pushes a surface which becomes an inner surface after the sheet bundle is folded.

A pair of fold rollers 38 is provided ahead of the movement direction of the fold blade 37. The sheet bundle pushed by the fold blade 37 is rolled into a nip portion of the pair of fold rollers 38, and the fold line is formed at the center portion of the sheet bundle.

The sheet bundle where the fold line has been formed by the pair of fold rollers 38 is transported to a fold reinforcing unit 50 provided at the downstream side thereof. The transportation of the sheet bundle transported to the fold reinforcing unit 50 is temporarily stopped there.

The fold reinforcing unit 50 is provided with reinforcing rollers 51 formed from a pair of rollers of an upper roller 51a and a lower roller 51b. The reinforcing rollers 51 move in the direction which is perpendicular to the transport direction of the sheet bundle (direction along the line of the fold line) while pressing the fold line and reinforce the fold line.

The sheet bundle, whose fold line has been reinforced by the reinforcing rollers 51 starts to be transported again, is pulled by a pair of discharge rollers 39, and is output to the sheet bundle placement unit 40. The sheet bundle (booklet) subjected to binding is placed on the sheet bundle placement unit 40.

### (2) Configuration and Operation of Fold Reinforcing Unit

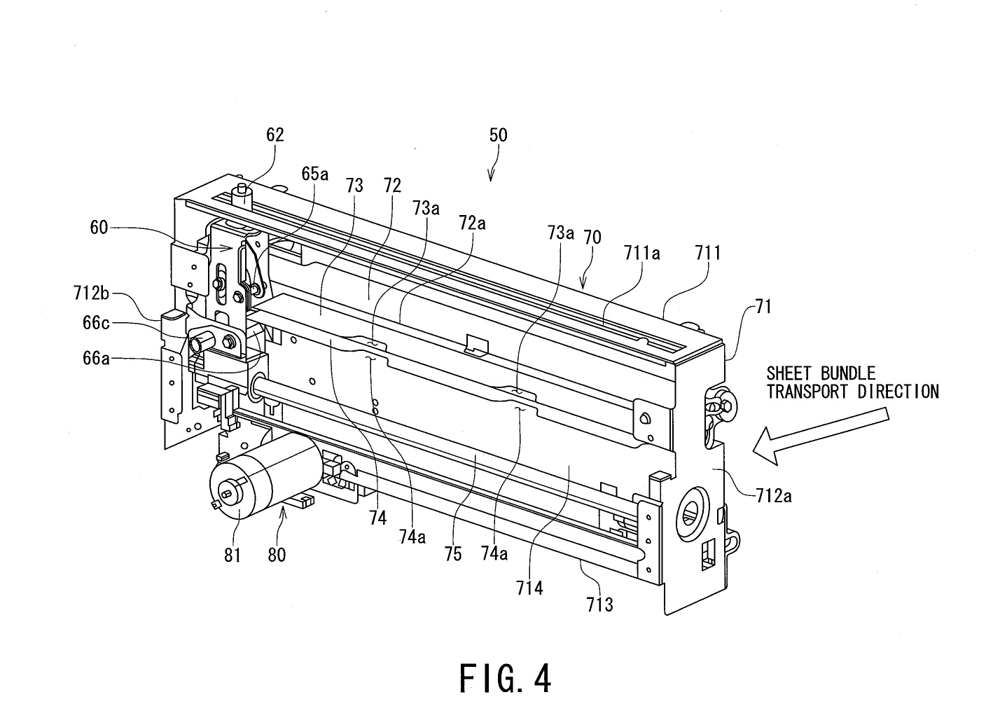

FIG. 4 is a perspective diagram illustrating an outer appearance of an entire configuration of the fold reinforcing unit (excluding the pair of discharge rollers 39). The fold reinforcing unit 50 includes a fold reinforcing roller unit 60 (simply referred to below as a roller unit 60), a support unit 70 and a drive unit 80.

The roller unit 60 has the reinforcing rollers 51, and the reinforcing rollers 51 nip and press the fold line of the sheet bundle pushed out from the pair of fold rollers 38 which are upstream and reinforce the fold line by moving along the fold line.

The support unit 70 supports the roller unit 60 so that the roller unit 60 is able to slide in the fold line direction and is configured from a member which nips the sheet bundle, a structural member of the entire fold reinforcing unit 50, and the like.

The drive unit 80 has a drive motor 81 and drives the roller unit 60 along the fold line using the drive motor 81.

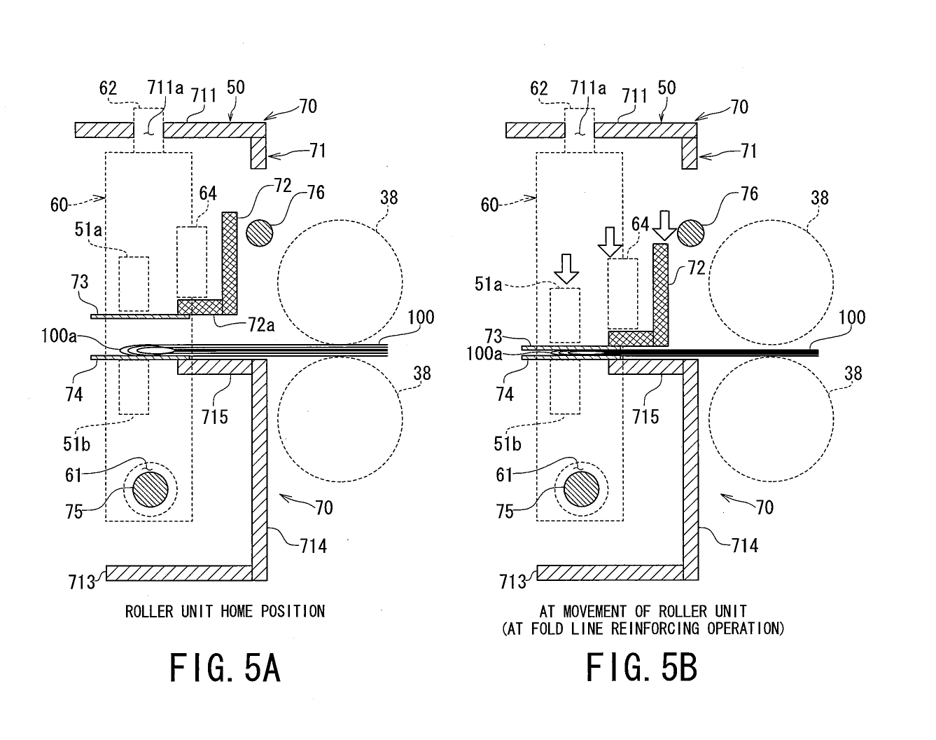

Out of the roller unit 60, the support unit 70 and the drive unit 80, the structure of the support unit 70 will be described first using FIGS. 4, 5A, and 5B. FIGS. 5A and 5B are schematic cross-sectional diagrams mainly describing a configuration of the support unit 70. FIG. 5A is a cross-sectional diagram when the roller unit 60 is at a home position (standby position: position at the left end of FIG. 4), and FIG. 5B is a cross-sectional diagram when the roller unit 60 is moving (reinforcing the fold line).

The support unit 70 includes a frame 71 (inner housing and fixing frame), and the frame 71 is configured by a top plate 711, right and left side plates 712a and 712b, a bottom plate 713, a back plate 714, a sheet bundle placement table 715 (see FIGS. 5A, 5B, and the like), and the like.

The top plate 711 is provided with a support hole 711a which extends in the longitudinal direction thereof.

In addition, a support shaft 75 which supports the roller unit 60, a transport guide 72 with an cross-section surface with an L shape, a drive shaft 76 (see FIGS. 5A, 5B, and the like) for driving the transport guide 72 in the up-and-down direction and the like are provided between the both side plates 712a and 712b.

A flexible member 73 with a strip shape, which is formed by a resin member such as polyethylene terephthalate (PET) in a film form, extends from a bottom plate 72a of the transport guide 72. A similar flexible member 74 also extends from the sheet placement table 715.

As shown in FIGS. 5A and 5B, a fold line 100a of a sheet bundle 100 is nipped between the flexible members 73 and 74 and is pressed by the pair of reinforcing rollers 51 (the upper roller 51a and the lower roller 51b) through the flexible members 73 and 74, and the fold line is reinforced. Damage or wrinkles in the fold line and in the vicinity thereof is prevented by using the flexible members 73 and 74.

Here, incisions 73a and 74b are provided at the leading ends of the flexible members 73 and 74. The incisions 73a and 74b are provided at positions corresponding to positions of staples on the fold line and prevent the flexible members 73 and 74 from being damaged by the staples.

A through hole 61 through which the support shaft 75 passes is provided in the lower portion of the roller unit 60. In addition, a support roller 62 for maintaining positioning is provided in the upper portion of the roller unit 60 and the support roller 62 moves along the support hole 711a provided in the top plate 711.

The position (excluding changing positions in the movement direction) and the positioning in the three axial directions of the roller unit 60 are regulated by the support shaft 75 and the through hole 61 described above, and the support hole 711a and the support roller 62, and the movement of the roller unit 60 is also kept constant.

Next, the configuration of the roller unit 60 will be described.

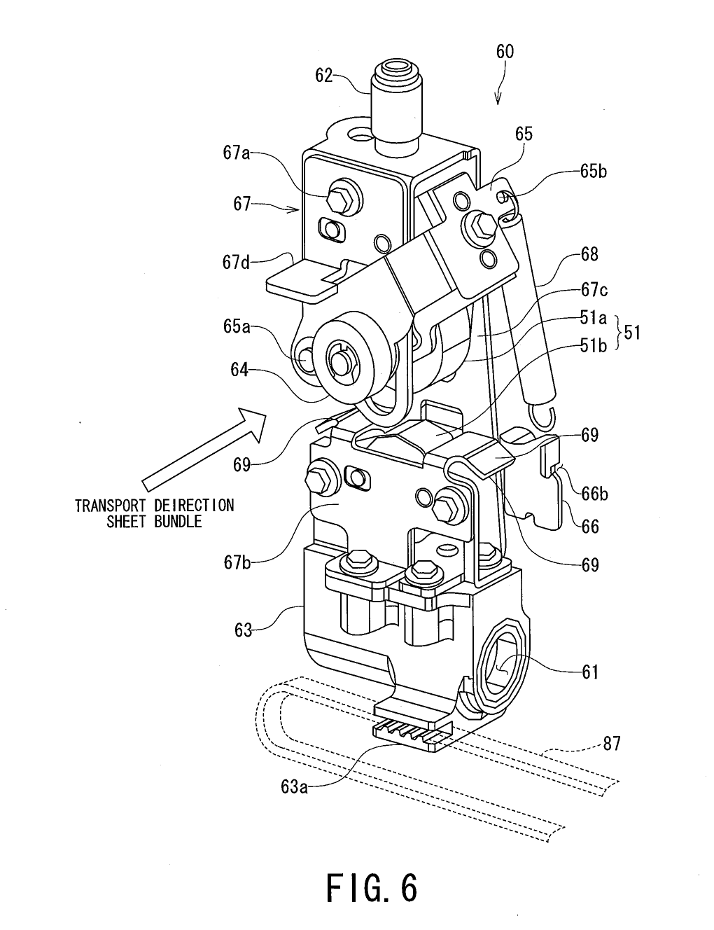

FIG. 6 is a perspective diagram illustrating an outer appearance of a configuration example of the roller unit 60 and is a diagram viewed in the direction the sheet bundle has been sent (opposite direction to FIG. 4).

The roller unit 60 is a unit with the pair of reinforcing rollers 51, and has a unit support section 63 provided with the through hole 61 and positioned at a lower part thereof and a unit frame 67 fixed to the upper part of the unit support section 63.

In the unit frame 67, an upper frame 67a which has a hollow section and a lower frame 67b which similarly has a hollow section are fixed and coupled by a frame plate 67c.

In addition, the roller unit 60 has an upper link member 65 and a lower link member 66, which are both spring coupled by a spring 68. One end of the spring 68 is engaged with a hook hole 65b of the upper link member 65 and the other end of the spring 68 is engaged with an incision 66b in the lower link member 66. The spring 68 is shown in FIG. 6 in a free state where the other end of the spring 68 is released from the incision 66b, but in a state where the other end of the spring 68 is actually engaged with the incision 66b, the pulling force of the spring 68 is applied between the upper link member 65 and the lower link member 66.

The lower roller 51b which is one of the pair of reinforcing rollers 51 is accommodated in the hollow section of the lower frame 67b. The lower roller 51b is pivotally-supported so as to be able to freely rotate around a lower roller shaft (not shown) fixed to the lower frame 67b.

On the side of the lower frame 67b, the lower link member 66 is coupled so as to be rotatable via a lower link shaft 66a (see FIG. 4) fixed to the lower frame 67b.

The upper roller 51a which is one of the pair of reinforcing rollers 51 is accommodated in the hollow section of the upper frame 67a. The upper roller 51a is pivotally supported so as to be able to freely rotate around an upper roller shaft (not shown) fixed to the upper link member 65 (and not the upper frame 67a).

The rotation shaft (lower roller shaft) of the lower roller 51b is fixed to the lower frame 67b (that is, fixed to the unit frame 67), and even if the roller unit 60 moves, the position of the lower roller 51b does not change in the up-and-down direction. The position of the upper end of the lower roller 51b is adjusted to be the same as the position of the flexible member 74, and when the roller unit 60 moves, the lower roller 51b rotates while coming in contact with the lower surface of the flexible member 74.

On the other hand, the upper roller shaft of the roller 51a is fixed to the upper link member 65. When the roller unit 60 separates from the home position and starts to move, the upper link member 65 is pulled by the spring 68 and starts to rotate downward around the upper link shaft 65a. Due to this rotation, the upper roller 51a, which is attached to the upper link member 65 so as to be rotatable, starts to be lowered and moves to a position where the upper roller 51a comes in contact with the lower roller 51b. A pressing force caused by the pulling force of the spring 68 mutually operates between the upper roller 51a and the lower roller 51b. In practice, since the sheet bundle is nipped between the upper roller 51a and the lower roller 51b through the flexible members 73 and 74, the fold line of the sheet bundle is reinforced by the pressing force between the upper roller 51a and the lower roller 51b.

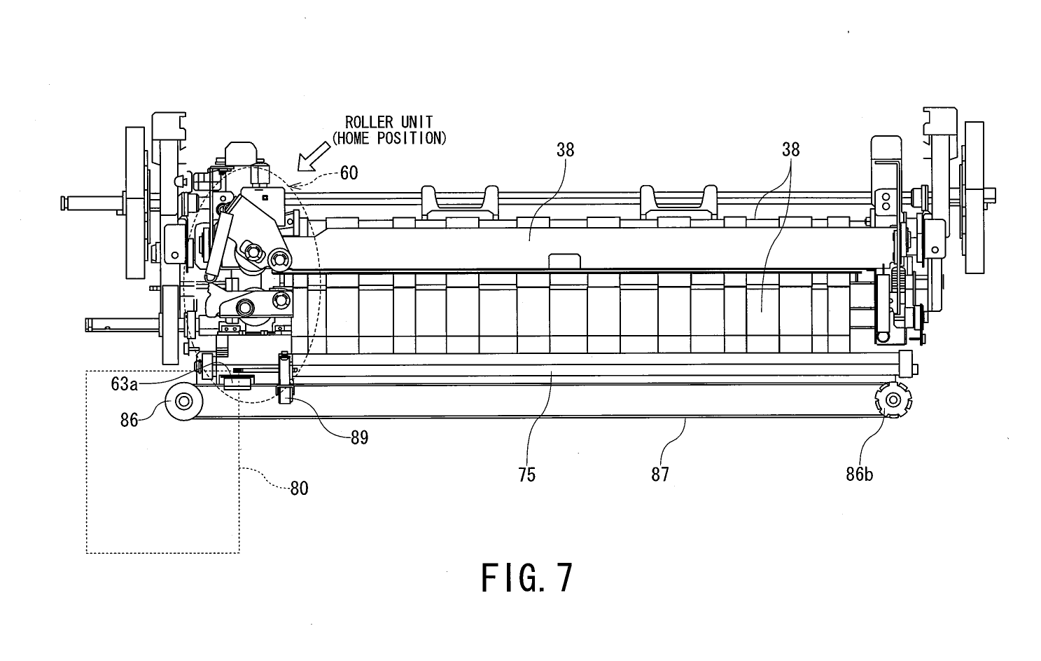

FIG. 7 is a diagram illustrating the positional relationship of the drive unit 80. FIG. 7 is a diagram viewing in the direction where the sheet bundle has been sent from the sheet bundle is to be sent, and also shows the roller unit 60 at the home position, the pair of fold rollers 38 and the drive mechanism of the pair of fold rollers 38. In addition, illustration of the structural members of the support unit 70 is partially omitted for convenience of description.

The drive unit 80 has the drive motor 81 and a row of gears in a portion encompassed by the dashed line in FIG. 7. The drive motor 81 is a DC motor, and it is possible for the rotation direction and rotation speed to be controlled from the outside.

The drive force due to the drive motor 81 is transmitted to a drive side gear pulley 86a via the row of gears. On the other hand, a unit drive belt 87 is stretched between the drive side gear pulley 86a and a driven side pulley 86b. The unit drive belt 87 moves between the drive side pulley 86a and the driven side pulley 86b using the drive force due to the drive motor 81.

A rack is formed on the surface of the unit drive belt 87, and due to the engagement of the rack and teeth of a fastening unit 63a (refer to FIG. 6) provided at the lower part of the roller unit 60, it is possible for the roller unit 60 to be reliably moved without sliding in the fold line direction. The movement direction of the unit drive belt 87 is able to be changed by reversing the rotation direction of the drive motor 81 and it is possible to move the roller unit 60 back and forward.

In the fold reinforcing unit 50, other than movement in the fold line direction of the roller unit 60, up-and-down driving of the upper roller 51a at an inner portion of the roller unit 60 and up-and-down driving of the transport guide 72 are performed and the drive source for both of the up-and-down driving is the driving motor 81. That is, the drive operation in the fold reinforcing unit 50 is all performed in total by the single drive motor 81.

A home position sensor 89, which detects the separation of the roller unit 60 from the home position and the return of the roller unit 60 to the home position is also shown in FIG. 7.

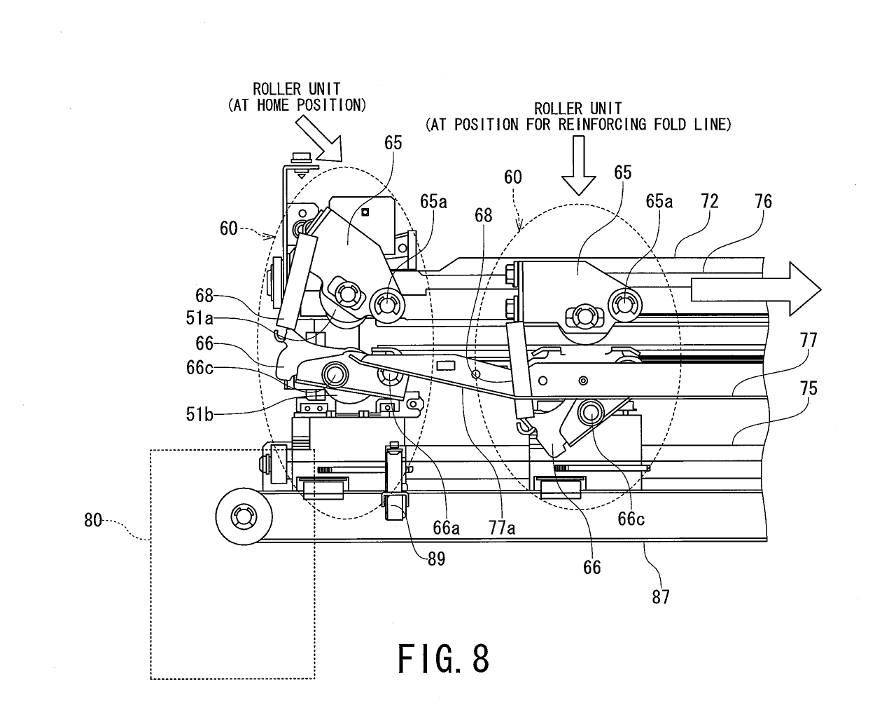

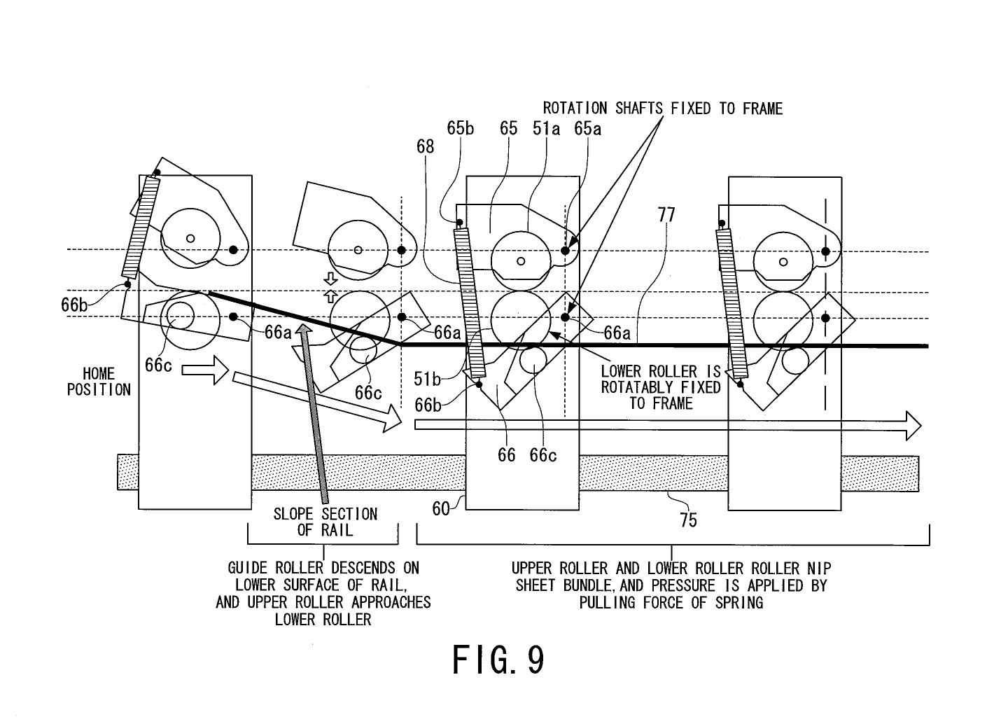

FIGS. 8 and 9 are diagrams describing up-and-down driving mechanism of the upper roller 51a. As described above, the upper link member 65 and the lower link member 66 of the roller unit 60 is spring coupled by the spring 68 in a position farthest from each of the rotation shafts (65a and 66a). In addition, a guide roller 66c (refer to FIG. 4) is provided so as to be able to freely rotate in the lower link member 66. That is, the lower link member 66 supports the guide roller 66c so as to be able to rotate between the rotation shaft 66a at one end thereof and the incision 66b at another end thereof (where the lower end of the spring 68 is engaged).

On the other hand, the support unit 70 has a guide rail 77 as shown in FIGS. 8 and 9. The guide rail 77 has a slope portion 77a which is inclined in the vicinity of the home position, and except for the slope portion 77a, the guide rail 77 is parallel to the fold line direction of the sheet bundle, i.e., horizontal.

When the roller unit 60 is driven by the drive belt 87 and is separated from the home position, and in time, the guide roller 66c comes into contact with the bottom surface of the slope portion 77a of the guide rail 77. After that, as shown in the second diagram from the left of FIG. 9, the guide roller 66c is lowered along the bottom surface of the slope portion 77a. As the guide roller 66c is lowered, the lower link member 66 rotates centered around the lower link shaft 66a in the counterclockwise direction of FIG. 9. In addition, the upper link member 65 is also pulled by the spring 68 and rotates centered around the upper link shaft 65b in the counterclockwise direction. As a result, the upper roller 51a between the upper link shaft 65a and the hook hole 65b of the spring 68 is gradually lowered while the roller unit 60 moves the slope portion 77a, and the gap between the upper roller 51a and the lower roller 51b is gradually narrowed. Then, the upper roller 51a and the lower roller 51b come in contact with each other in the vicinity of an area where the slope portion 77a ends. At this time, pressure (pushing force) acts between the upper roller 51a and the lower roller 51b which push against each other. The pushing force is based on the pulling force of the spring 68.

In a horizontal area (that is, the effective drive area) of the guide rail 77, the upper roller 51a and the lower roller 51b apply pressure to the fold line of the sheet bundle and reinforce the fold line while keeping the pushing force.

### (3) Paper Jam Release Mechanism

If a paper jam occurs during fold reinforcing due to any cause, the fold reinforcing rollers 51 stop in a state where the fold line of the sheet bundle is being nipped. In this situation, it is necessary to remove the sheet bundle, that is, perform a paper jam release.

The sheet finisher 20 according to the embodiment has two paper jam release mechanisms described below, and it is possible to easily remove the sheet bundle which has caused the paper jam using the following two paper jam release mechanisms.

The first paper jam release mechanism makes access of a user easy with regard to the sheet bundle which has caused the paper jam. The second paper jam release mechanism is a mechanism which makes the removal of the sheet bundle easy by weakening or removing the pressure of the fold reinforcing rollers which are nipping the sheet bundle.

### (4) First Paper Jam Release Mechanism

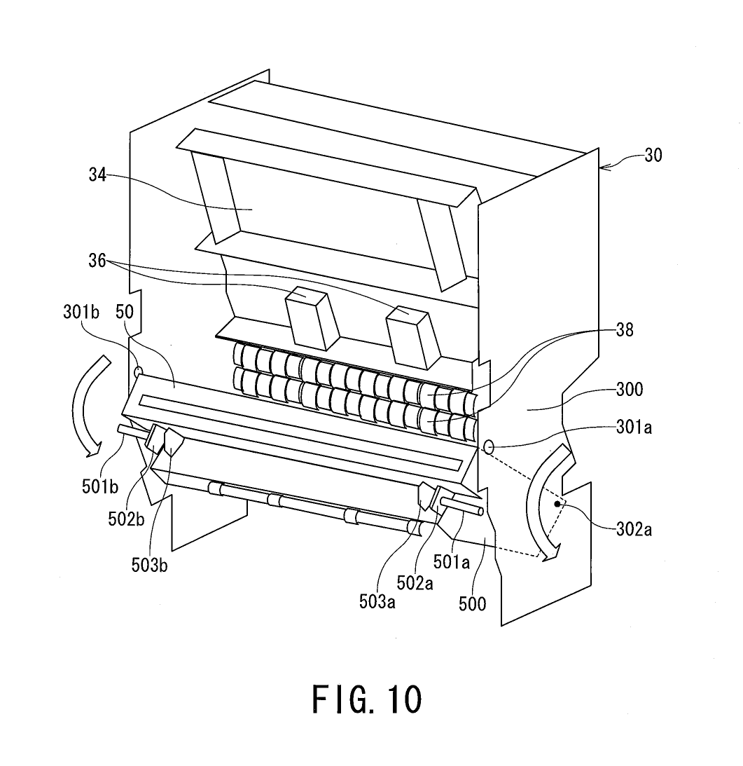

First, the first paper jam release mechanism will be described using FIGS. 10, 11A, 11B, 12A and 12B.

As shown in FIG. 10, the saddle stitching unit 30 of the sheet finisher 20 has an external housing 300 and an internal housing 500. The external housing 300 mainly accommodates the unit which performs the center folding such as the standing tray 34, the stapler 36, and the pair of fold rollers 38.

On the other hand, the internal housing 500 accommodates the unit of the roller unit 60 and the like which is mainly related to fold reinforcing.

The internal housing 500 has support shafts 302a and 302b in a lower portion thereof on a front side and rear side, respectively. The internal housing 500 is pivotally supported so as to be able to rotate freely with the external housing 300 due to the support shafts 302a and 302b. In FIG. 10, only a support shaft 302a on the front side can be seen.

In addition, the internal housing 500 has engaging rods 501a and 501b, jam release handles 502a and 502b, and fixed handles 503a and 503b in an upper portion of both sides. During normal driving, the engaging rods 501a and 501b are inserted in elongated holes 301a and 301b which are formed on both sides of the external housing 300, that is, during normal driving, the internal housing 500 engages with the external housing 300 using the engaging rods 501a and 501b and the elongated holes 301a and 301b.

On the other hand, when a paper jam occurs, the engagement of the external housing 300 and the internal housing 500 is manually released and it is possible to open the internal housing 500 around the support shafts 302a and 302b in a discharging direction of the sheet bundle.

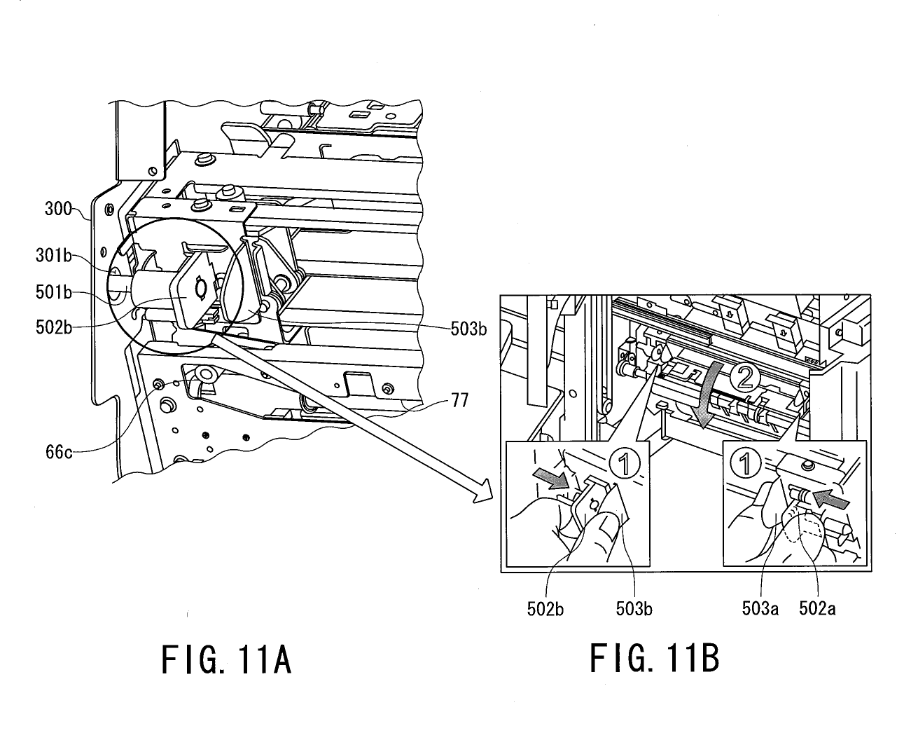

FIG. 11A is a diagram illustrating the configuration of the engaging rod 501b on the rear side and the vicinity thereof. FIG. 11A shows a state (during normal driving) when the internal housing 500 (that is, the fold reinforcing unit 50) is accommodated in the external housing 300. As shown in FIG. 11A (also refer to FIG. 10), one end of the engaging rod 501b is connected and fixed to the jam release handle 502b while the other end of the engaging rod 501b is inserted in the elongated hole 301b of the external housing 300. In addition, the fixed handle 503b is provided adjacent to the jam release handle 502b. The jam release handle 502b is configured to be able to move in a rear-and-front direction (that is, the fold line direction of the sheet bundle) along with the engaging rod 501b. That is, the jam release handle 502b and the engaging rod 501b are able to slide in the rear-and-front direction with regard to the internal housing 500. On the other hand, the fixed handle 503b is fixed with regard to the internal housing 500. The rod 501a, the jam release handle 502a, and the fixed handle 503a on the front side have the same configuration.

Releasing a paper jam, as shown in FIG. 11B, for example, the jam release handle 502b and the fixed handle 503b on the rear side are pinched by a thumb and an index finger of a left hand, and the jam release handle 502a and the fixed handle 503a on the front side are pinched by a thumb and an index finger of a right hand. Then, by the jam release handles 502a and 502b being each moved to the inner side and the engaging rods 501a and 501b being extracted from the elongated holes 301a and 301b of the external housing 300, the engagement of the internal housing 500 and the external housing 300 is released. After that, by the jam release handles 502a and 502b and the fixed handles 503a and 503b being pinched with both hands while being pulled downwards toward the front, it is possible to open down the internal housing 500 (that is, the fold reinforcing unit 50) toward the outside.

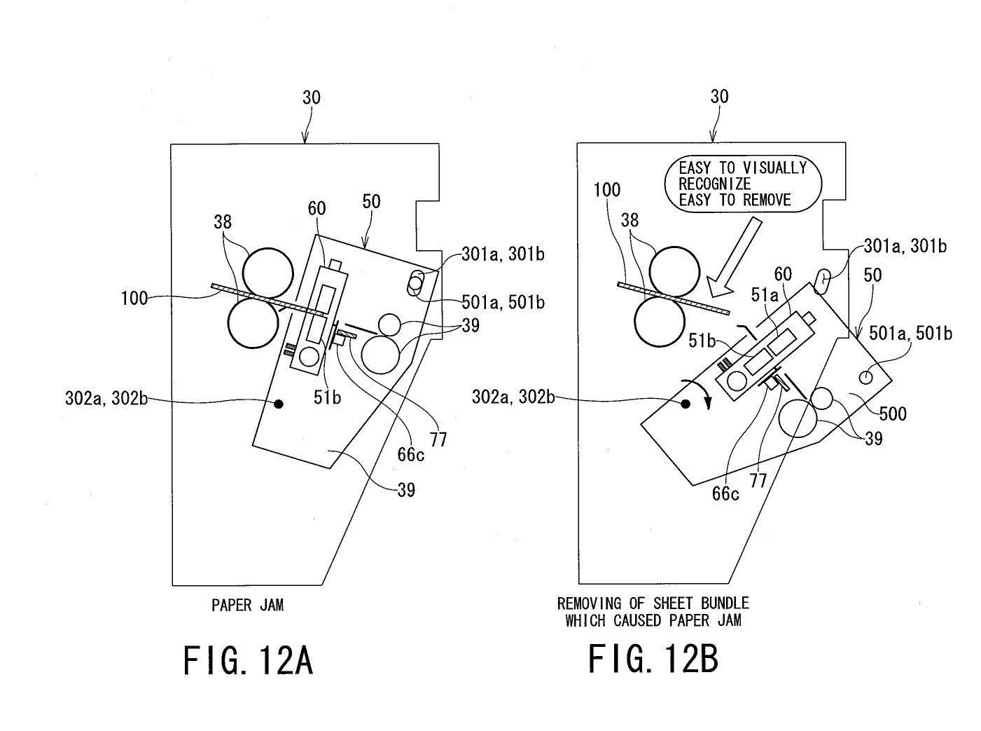

FIGS. 12A and 12B are schematic cross-sectional diagrams viewed from the rear side which are for more clearly describing the movement of the fold reinforcing unit 50 described above.

FIG. 12A shows a state where the fold reinforcing unit 50 is accommodated. It is assumed that a paper jam has occurred in this state and the roller unit 60 stops in a state where the sheet bundle is nipped. For this case, a user manually moves the jam release handles 502a and 502b, as described above, to extract the engaging rods 501a and 501b from the elongated holes 301a and 301bof the external housing 300, resulting that the fold reinforcing unit 50 is pulled downwards toward the outside. In this manner, the fold reinforcing unit 50 rotates around the support shafts 302a and 302b in the lower portion thereof and the fold reinforcing unit 50 is opened down as shown in FIG. 12B. When the fold reinforcing unit 50 is opened down, a sheet bundle 100 is exposed in a state of being nipped by the pair of fold rollers 38 and a space between the fold reinforcing unit 50 and the pair of fold rollers 38 is widely formed. Accordingly, it is possible for the user to easily visually recognize the sheet bundle 100 which has caused the paper jam and it is also possible to easily remove the sheet bundle 100.

### (5) Second Paper Jam Release Mechanism

As mentioned above, if a paper jam occurs during fold reinforcing, the roller unit 60 is stopped in a state where the upper roller 51a and the lower roller 51b apply pressure to the fold line of the sheet bundle. Therefore, when a user opens the fold reinforcing unit 50 using the first paper jam release mechanism described above, the user needs to pull the fold reinforcing unit 50 downwards against the pressure of the upper roller 51a and the lower roller 51b which are nipping the fold line, and the user needs to pull it down while applying a certain degree of strong force. In addition, since the rotation direction of the upper roller 51a and the lower roller 51b and the downward pulling direction of the fold reinforcing unit 50 are orthogonal, there is a possibility of damaging the roller unit 60.

In view of this problem, the second paper jam release mechanism is provided with a unit for weakening or removing the pressure between the upper roller 51a and the lower roller 51b in releasing a paper jam.

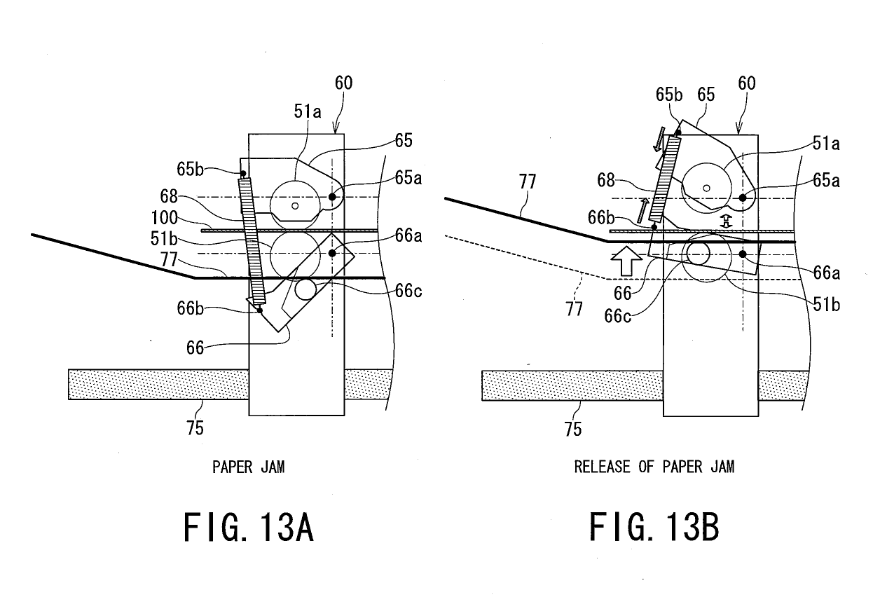

FIGS. 13A and 13B are diagrams illustrating the operating concept of the second paper jam release mechanism. FIG. 13A shows a state in which a paper jam has occurred due to any cause during reinforcing of the fold line of the sheet bundle 100 using the upper roller 51a and the lower roller 51b, and the movement of the upper roller 51a and the lower roller 51b (movement along the fold line) has stopped.

As described above, during fold reinforcing, the upper surface of the guide roller 66c of the roller unit 60 is in contact with the lower surface of the guide rail 77. The contact position is lower than the supporting point of the lower link member 66 (lower link shaft 66a). Also, the incision 66b which is at the leading end of the lower link member 66 is further lower than the contact position of the guide roller 66c. As a result, one end of the spring 68 which is engaged with the incision 66b is pulled downward and a pushing force is generated based on the pulling force of the spring 68 between the upper roller 51a and the lower roller 51b.

Therefore, in order for the pushing force between the upper roller 51a and the lower roller 51b to be weakened or removed, it is sufficient to move the incision 66b, which is engaged with the spring 68, upward (in the thickness direction of the sheet bundle) and to weaken the pulling force of the spring 68. Further, in order to move the incision 66b upward, it is sufficient to move the guide roller 66c upward, and for this, it is sufficient to move the guide rail 77, which is in contact with the upper surface of the guide roller 66c, upward. That is, as shown in FIG. 13B, it is possible to weaken or remove the pushing force between the upper roller 51a and the lower roller 51b by moving the guide rail 77 upward in the thickness direction of the sheet bundle.

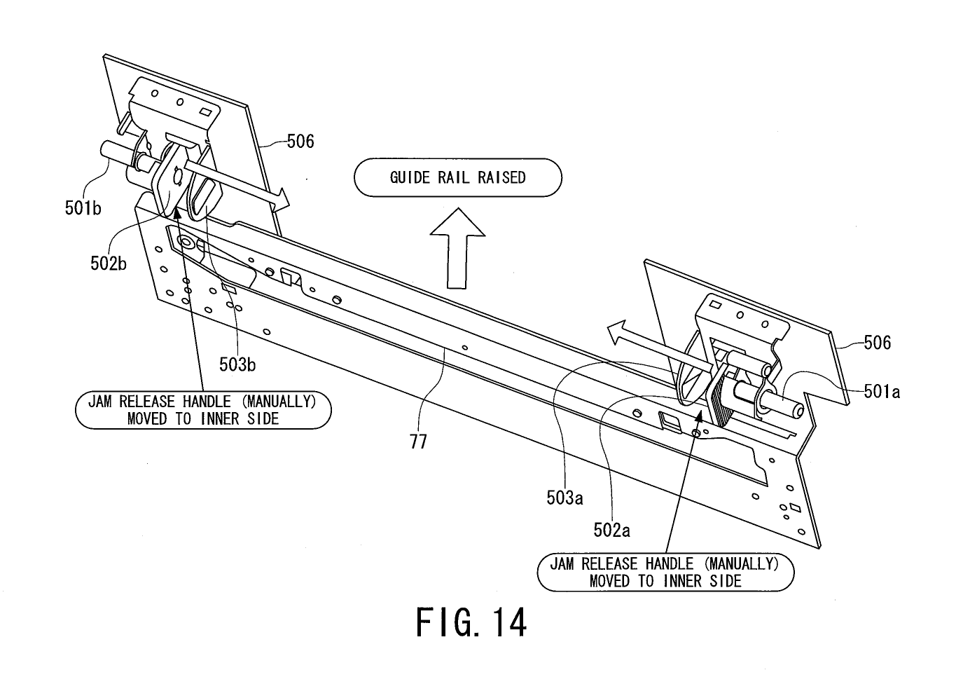

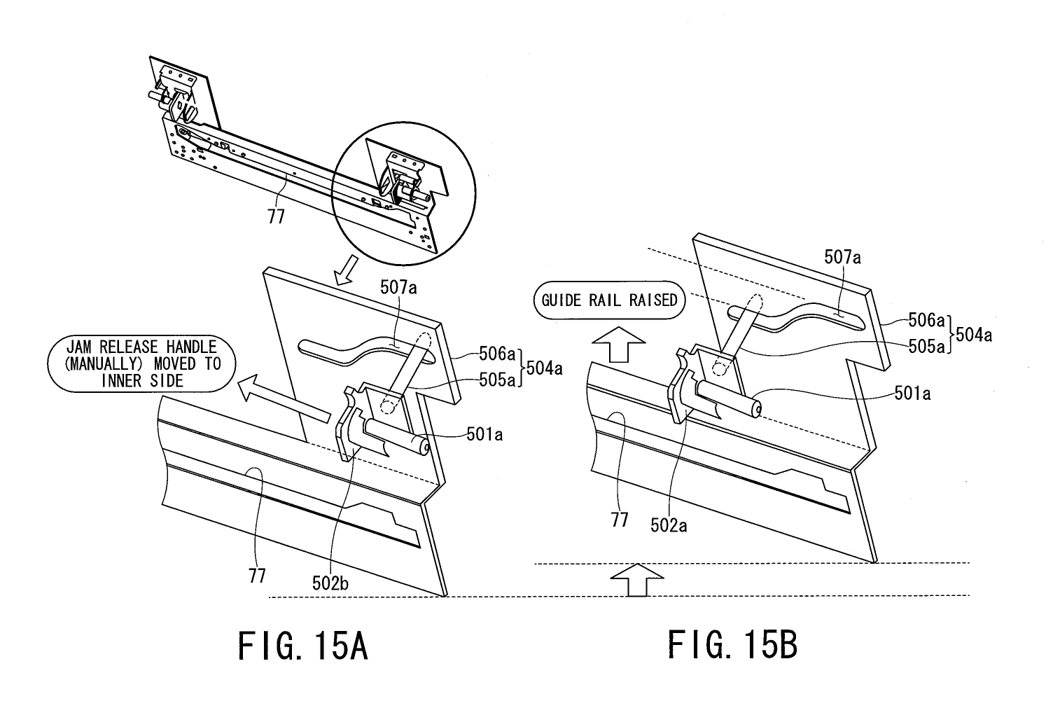

FIGS. 14, 15A, and 15B are diagrams describing the second jam release mechanism, more specifically, a mechanism which raises the guide rail 77.

As shown in FIG. 14, the second jam release mechanism operates in conjunction with the first jam release mechanism. That is, even in the second jam release mechanism, the jam release handles 502a and 502b are also manually moved to the inner side for raising the guide rail 77.

FIGS. 15A and 15B are diagrams describing the second jam release mechanism in more detail. The front side and rear side have basically the same configuration and only the front side of the second jam release mechanism is shown in FIGS. 15A and 15B.

The second jam release mechanism is provided with a connection member 504a which connects the jam release handle 502a and the guide rail 77. The connection member 504a has a slide rod 505a which is fixed and connected to the jam release handle 502a and a connection plate 506a which is fixed and connected to the guide rail 77. A elongated hole 507a with a level difference is formed in the connection plate 506a. The slide rod 505a is able to slide up or down the level difference in a longitudinal direction of the elongated hole 507a in a state of being inserted in the elongated hole 507a.

Here, a connection member 504b (slide rod 505b, connection plate 506b) and elongated hole 507b are provided in the same manner also on the rear side.

Due to a manual operation, movement of the jam release handle 502a along an inner side and an outer side direction with respect to the internal housing 500 is allowed. By contrast, movement of the jam release handle 502a along the up-and-down direction (in the thickness direction of the sheet bundle) with respect to the internal housing 500 is restricted. That is, a vertical position of the jam release handle 502a with respect to the internal housing 500 is not changed even if the jam release handle 502a is manually moved in a horizontal (an inner side and an outer side) direction.

FIG. 15A is a diagram illustrating a state before jam release, and at this time, the slide rod 505a is in a high position on the level difference of the elongated hole 507a. When the user pinches and moves the jam release handle 502b to the inner side, the slide rod 505a also moves to the inner side. Then, as shown in FIG. 15B, the slide rod 505a moves to a low position on the level difference of the elongated hole 507a. As described above, the position in the up-and-down direction of the jam release handle 502b (and the slide rod 505a which is connected and fixed to the jam release handle 502b) does not change with regard to the internal housing 500 (fixed frame). As a result, when the slide rod 505a moves to the low position of the level difference of the elongated hole 507a, the connection plate 506a and the guide rail 77 which is connected and fixed to the connection plate 506a are raised with regard to the internal housing 500.

When the guide rail 77 is raised with regard to the internal housing 500, as shown in FIG. 13B, the pulling force of the spring 68 is weakened and the pushing force between the upper roller 51a and the lower roller 51b is weakened or removed.

At this time, in conjunction with the manual operation of the jam release handles 502a and 502b, the engaging rods 501a and 501b are extracted from the elongated holes 301a and 301b of the internal housing 500. That is, due to the operation where the jam release handles 502a and 502b are moved to the inner side, it is possible to weaken or remove the pushing force between the upper roller 51a and the lower roller 51b, and at the same time, release the engagement of the internal housing 500 of the fold reinforcing unit 50 and the external housing 300 of the saddle stitching unit 30.

As a result, excess force from a user is not necessary, there is no concern of damage to the upper roller 51a and the lower roller 51b, and it is possible to open up the fold reinforcing unit 50 to the outer side.

After that, it is possible for the user to easily remove the sheet bundle as shown in FIG. 12B.

As described above, according to the sheet finisher, the image forming apparatus, and the sheet finishing method of the embodiment, it is possible to easily remove the sheet bundle which caused a paper jam by an extremely simple operation even in a case where fold reinforcing is stopped by the paper jam.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finisher comprising:
a fold roller which folds the center of a sheet bundle and forms a fold line in the sheet bundle;
a roller unit which is provided with an upper roller and a lower roller and which moves the upper roller and the lower roller along a fold line direction, while nipping and pressing the fold line by the upper roller and the lower roller to reinforce the fold line; and
a jam release handle which separates the upper roller and the lower roller in a thickness direction of the sheet bundle and weakens or removes pressure between the upper roller and the lower roller when the upper roller and the lower roller stops in a state of pressing the fold line.

2. The sheet finisher of claim 1,
wherein the roller unit has a spring which pressurizes the upper roller and the lower roller due to a pulling force thereof, and
the jam release handle weakens the pulling force of the spring and weakens or removes the pressure between the upper roller and the lower roller by moving one end of the spring in a thickness direction of the sheet bundle.

3. The sheet finisher of claim 2, further comprising:
a fixed frame which supports the roller unit so as to slide in the fold line direction; and
a guide rail which moves in the thickness direction of the sheet bundle with regard to the fixed frame due to an operation of the jam release handle,
wherein,
the roller unit has a guide roller which freely rotates while coming into contact with the guide rail and a link member, one end of the link member being pivotally supported by a frame of the roller unit and the other end the link member being engaged with one end of the spring,
the guide roller is rotatably supported between the one end and the other end of the link member, and
the pulling force of the spring is weakened by shortening a pulling length of the spring when the guide rail and the guide roller which is in contact with the guide rail are moved upward in the thickness direction of the sheet bundle due to an operation of the jam release handle.

4. The sheet finisher of claim 2,
wherein a position of the lower roller is fixed and a position of the upper roller is variable in the thickness direction of the sheet bundle,
when reinforcing the fold line, the upper roller moves downward in a thickness direction of the sheet bundle to pressurize the lower roller due to the pulling force of the spring, and
when releasing a paper jam, the upper roller is moved upward in the thickness direction of the sheet bundle to separate from the lower roller by weakening the pulling force of the spring being weakened.

5. The sheet finisher of claim 3,
wherein the jam release handle and the guide rail are connected via a connection member, and
the guide rail moves in the thickness direction of the sheet bundle due to the operation of the jam release handle.

6. The sheet finisher of claim 5,
wherein the connection member changes movement of the jam release handle in the fold line direction of the sheet bundle to movement in the thickness direction of the sheet bundle.

7. The sheet finisher of claim 1, further comprising:
an external housing; and
an internal housing which accommodates the roller unit,
wherein the internal housing is pivotally supported with the external housing by a support shaft provided in a lower portion thereof and engages with the external housing at an upper portion thereof, and
the internal housing is configured to be opened around the support shaft toward a discharging direction of the sheet bundle by releasing engagement of the external housing and the internal housing so as to expose the fold roller when a paper jam occurs.

8. The sheet finisher of claim 7,
wherein the jam release handle is used to weaken or remove the pressure between the upper roller and the lower roller as well as being used to release the engagement of the external housing and the internal housing.

9. The sheet finisher of claim 8,
wherein the jam release handle is provided on both ends of an upper portion of the internal housing.

10. An image forming apparatus comprising:
a read-out unit which reads out an original document;
an image forming unit which prints out image data of the read-out original document onto a sheet using an electrophotographic method;
a fold roller which folds the center of a sheet bundle of plurality of the printed sheets and forms a fold line in the sheet bundle;
a roller unit which is provided with an upper roller and a lower roller and which moves the upper roller and the lower roller along a fold line direction, while nipping and pressing the fold line by the upper roller and the lower roller to reinforce the fold line; and
a jam release handle which separates the upper roller and the lower roller in a thickness direction of the sheet bundle and weakens or removes pressure between the upper roller and the lower roller when the upper roller and the lower roller stops in a state of pressing the fold line.

11. The apparatus according claim 10,
wherein the roller unit has a spring which pressurizes the upper roller and the lower roller due to a pulling force thereof, and
the jam release handle weakens the pulling force of the spring and weakens or removes the pressure between the upper roller and the lower roller by moving one end of the spring in a thickness direction of the sheet bundle.

12. The apparatus according claim 11, further comprising:
a fixed frame which supports the roller unit so as to slide in the fold line direction; and
a guide rail which moves in the thickness direction of the sheet bundle with regard to the fixed frame due to an operation of the jam release handle,
wherein,
the roller unit has a guide roller which freely rotates while coming into contact with the guide rail and a link member, one end of the link member being pivotally supported by a frame of the roller unit and the other end the link member being engaged with one end of the spring,
the guide roller is rotatably supported between the one end and the other end of the link member, and
the pulling force of the spring is weakened by shortening a pulling length of the spring when the guide rail and the guide roller which is in contact with the guide rail are moved upward in the thickness direction of the sheet bundle due to an operation of the jam release handle.

13. The apparatus according claim 11,
wherein a position of the lower roller is fixed and a position of the upper roller is variable in the thickness direction of the sheet bundle,
when reinforcing the fold line, the upper roller moves downward in a thickness direction of the sheet bundle to pressurize the lower roller due to the pulling force of the spring, and
when releasing a paper jam, the upper roller is moved upward in the thickness direction of the sheet bundle to separate from the lower roller by weakening the pulling force of the spring being weakened.

14. The apparatus according claim 12,
wherein the jam release handle and the guide rail are connected via a connection member, and
the guide rail moves in the thickness direction of the sheet bundle due to the operation of the jam release handle.

15. The apparatus according claim 14,
wherein the connection member changes movement of the jam release handle in the fold line direction of the sheet bundle to movement in the thickness direction of the sheet bundle.

16. The apparatus according claim 10, further comprising:
an external housing; and
an internal housing which accommodates the roller unit,
wherein the internal housing is pivotally supported with the external housing by a support shaft provided in a lower portion thereof and engages with the external housing at an upper portion thereof, and
the internal housing is configured to be opened around the support shaft toward a discharging direction of the sheet bundle by releasing engagement of the external housing and the internal housing so as to expose the fold roller when a paper jam occurs.

17. The apparatus according claim 16,
wherein the jam release handle is used to weaken or remove the pressure between the upper roller and the lower roller as well as being used to release the engagement of the external housing and the internal housing.

18. The apparatus according claim 17,
wherein the jam release handle is provided on both ends of an upper portion of the internal housing.

19. A sheet finishing method comprising:
folding the center of a sheet bundle using a fold roller and forming a fold line in the sheet bundle;
moving an upper roller and a lower roller along a fold line direction while the fold line of the sheet bundle is being nipped and pressed by the upper roller and the lower roller to reinforce the fold line; and
separating the upper roller and the lower roller in a thickness direction of the sheet bundle using a jam release handle, and weakening or removing pressure between the upper roller and the lower roller when the upper roller and the lower roller stops in a state of pressing the fold line.

20. The method according claim 19,
wherein the upper roller and the lower roller are pressurized due to a pulling force of a spring, and
the jam release handle weakens the pulling force of the spring and weakens or removes the pressure between the upper roller and the lower roller by moving one end of the spring in a thickness direction of the sheet bundle.
